(19) United States
(12) Patent Application Publication
(10) Pub. No.: US 2018/0211167 A1
(43) Pub. Date: Jul. 26, 2018

(54) HEURISTIC ALARM AND EVENT AGGREGATION AND CORRELATION METHOD FOR SERVICE PROVIDER NETWORK OPERATION

(71) Applicant: CISCO TECHNOLOGY, INC., San Jose, CA (US)

(72) Inventors: Ya Xu, Sunnyvale, CA (US); Atul Prakash, San Jose, CA (US)

(73) Assignee: CISCO TECHNOLOGY, INC., San Jose, CA (US)

(21) Appl. No.: 15/623,324

(22) Filed: Jun. 14, 2017

Related U.S. Application Data
(60) Provisional application No. 62/450,457, filed on Jan. 25, 2017.

(51) Int. Cl. G06N 5/00

(52) U.S. Cl. CPC G06N 5/003

(57) ABSTRACT

In one embodiment, a method for heuristic event aggregation and correlation includes grouping events from a same device into event groups. Neighboring events in an event group have a timestamp gap of less than a defined timestamp gap threshold. Correlation of events is performed within event groups between devices. One or more alerts are generated based on the correlation. The method can systematically reduce millions of events into alerts which can be understood by human administrators, who can triage and troubleshoot for problems in ways which would not have been possible without the method.

### PRIORITY DATA

This is a non-provisional application of U.S. Provisional Patent Application entitled “HEURISTIC ALARM AGGREGATION AND CORRELATION METHOD FOR SERVICE PROVIDER NETWORK OPERATION” filed on Jan. 25, 2017 with Ser. No. 62/450,457. The U.S. Provisional is hereby incorporated herein in its entirety.

### TECHNICAL FIELD

This disclosure relates in general to the field of computing, more specifically, to a heuristic alarm and event aggregation and correlation method for service provider network operation.

### BACKGROUND

Service providers' operation teams face the challenge of dealing with ever-increasing massive logs having many alarms/events, generated from thousands of devices in the network. It becomes more and more urgent for the service providers to quickly identify the root causes of the issue and restore the service within minutes or shorter. However, due to the complexity of network and the scaling of alarms/events, the current network troubleshooting time averages in days, which is far longer than what would be acceptable. The length of time needed for trouble shooting often does not meet the requirements and business needs of network operations.

### BRIEF DESCRIPTION OF THE DRAWINGS

To provide a more complete understanding of the disclosure and features and advantages thereof, reference is made to the following description, taken in conjunction with the accompanying FIGURES, wherein like reference numerals represent like parts, in which:

FIG. 1 illustrates an exemplary networked system, according to some embodiments of the disclosure;

FIG. 2 illustrates methodology for heuristic alarm and event aggregation and correlation, according to some embodiments of the disclosure;

FIG. 3 illustrates exemplary event groups, according to some embodiments of the disclosure;

FIG. 4 illustrates a method for determining time frames, according to some embodiments of the disclosure;

FIG. 5 illustrates exemplary time frames within a time window, according to some embodiments of the disclosure;

FIG. 6 shows a flow diagram illustrating an exemplary method for heuristic alarm and event aggregation and correlation, according to some embodiments of the disclosure; and

FIG. 7 depicts a block diagram illustrating an exemplary data processing system that may be used to implement alarm processing, according to some embodiments of the disclosure.

### DETAILED DESCRIPTION OF EXAMPLE EMBODIMENTS

### Overview

To enable an operations team to review the alarms faster, the heuristic alarm and event aggregation and correlation method aims to drastically reduce the amount of alarms, so that a human operator can more easily and quickly review the log.

In one embodiment, a method for heuristic event aggregation and correlation includes grouping events from a same device into event groups. Neighboring events in an event group have a timestamp gap of less than a defined timestamp gap threshold. Correlation of events is performed within event groups between devices. One or more alerts are generated based on the correlation.

The method can systematically reduce millions of events into alerts which can be understood by human administrators, who can triage and troubleshoot for problems in ways which would not have been possible without the method.

One aspect of the disclosure relates to computer-implemented methods for heuristic alarm and event aggregation and correlation method for service provider network operation. Another aspect of the disclosure relates to one or more computer-readable non-transitory media comprising one or more instructions, for heuristic event aggregation and correlation, that when executed on a processor configure the processor to perform one or more operations described herein.

In other aspects, systems for implementing the methods described herein are provided. Moreover, a computer program for carrying out the methods described herein, as well as a non-transitory computer-readable storage medium storing the computer program are provided. A computer program may, for example, be downloaded (updated) to the existing network devices and systems (e.g. to the existing routers, switches, various control nodes and other network elements, etc.) or be stored upon manufacturing of these devices and systems.

In other aspects, apparatuses comprising means for carrying out one or more of the method steps are envisioned by the disclosure.

As will be appreciated by one skilled in the art, aspects of the disclosure, in particular the functionalities related to heuristic alarm and event aggregation and correlation method for service provider network operation, may be embodied as a system, a method or a computer program product. Accordingly, aspects of the disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a processor, e.g., a microprocessor, of a computer. Furthermore, aspects of the disclosure may take the form of a computer program product embodied in one or more computer-readable medium(s) having computer-readable program code embodied, e.g., stored, thereon.

### Example Embodiments

Challenges to Reviewing Logs

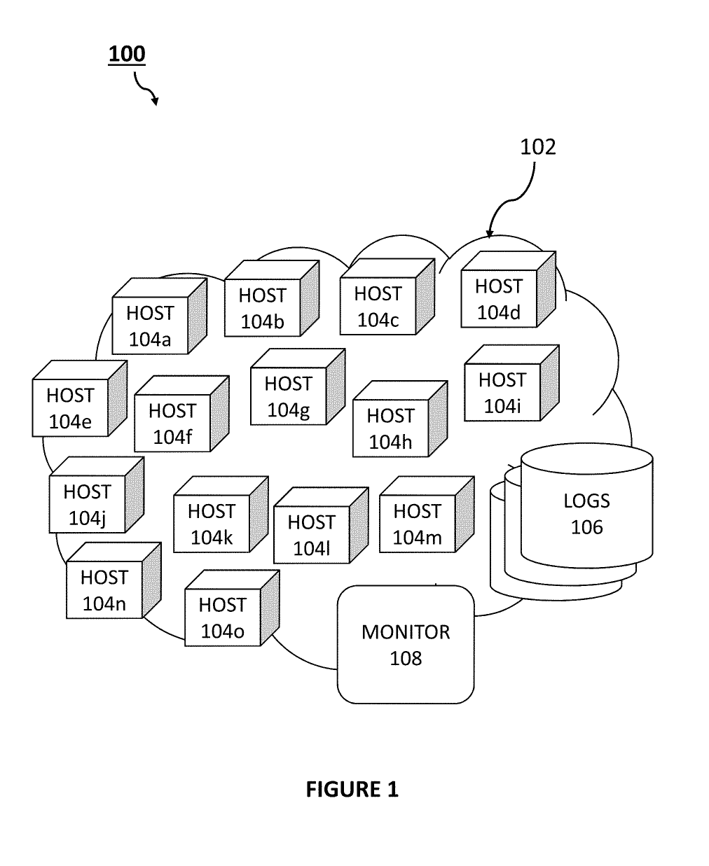

It would be advantageous for operation teams have to be able to achieve faster network troubleshooting in large-scale networks. In modern data centers or networked systems, devices or virtual devices emulated on hardware often monitor themselves and generate events and alarms. FIG. 1 illustrates an exemplary networked system, according to some embodiments of the disclosure. The networked system includes a communication network 102. Using the communication network 102, many devices or virtual devices can be provisioned to provide functionalities and services. The devices or virtual devices can represent physical and/or virtual forms of storage, compute, and/or network resources. For simplicity, these devices or virtual devices are called “devices”, “hosts”, or “host machines” herein. Hosts are illustrated in FIG. 1 as hosts 104a-o, but any number of devices are envisioned. The embodiments described are not limited to just hosts or host machines.

The number of alarms and events can be many thousands to millions, and the alarms and events can be sent to and stored in logs 106 (comprising non-transitory computer-readable storage medium). “Alarms”, used herein, can encompass both events and alarms. “Events”, used herein, can also encompass both events and alarms. Events and alarms can be used interchangeably. Generally speaking, alarms and events are generated based on rules. A rule can specify a condition of the host to check for, and if the condition is met, an alarm or an event can be triggered or generated. A notification would be generated to notify an operator of the alarm or the event. An event can be a less severe alarm. Logs 106 are accessible by monitor 108 (implemented on physical computing hardware), which is configured to process the logs. The alarms/events generated by hosts are stored in logs 106, so that an operations team can process it, e.g., for troubleshooting. Operation teams can view the logs from monitor 108. Alarms/events are generally timestamped. Alarms/events would also include identifying information for the host, and information associated with the alarm/event or condition associated with the rule that triggered the alarm/event. Such information can be provided as parameters/attributes of events. Parameters/attributes can include one or more of the following: message type, message description, severity, and location.

Consider an example log in logs 106, which can have 100 days of data (including alarms and/or events) having 10000 host machines being monitored. A single day of data file can include more than 1 million alarms, and 3000 different hosts. The task of examining log having this many alarms/events is incredibly challenging and time consuming for a human operator or team of operators. A given host can generate thousands of alarms/events over the many days in the log. It is practically impossible for human operators to understand millions of alarms/events.

Heuristic Aggregation and Correlation Methodology

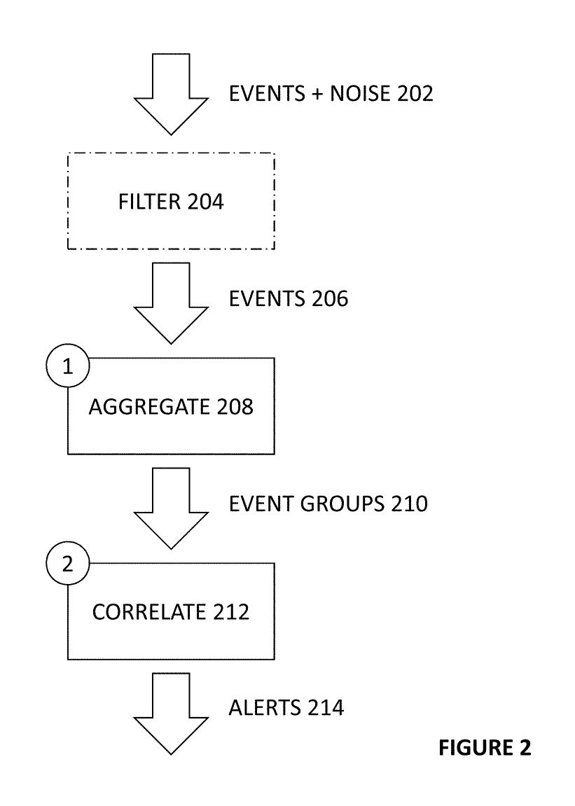

FIG. 2 illustrates methodology for heuristic alarm and event aggregation and correlation, according to some embodiments of the disclosure. The heuristic alarm and event aggregation and correlation method systematically aggregates massive, all in a mess network alarms/events into event groups based on their time inherency, and correlate these event groups under event time windows based on their overlap in timespan. It can work in online or offline mode to help reduce network troubleshooting time for both single-device and multi-device systems. The scheme can be particularly advantageous in large-scale network environment.

The heuristic alarm and event aggregation and correlation methodology includes a two-stage process to classify large-scale data files or logs having many events/alarms from all network devices into smaller time-based windows within which the events/alarms have inherent relationship so that an operator can troubleshoot network issues faster. In Stage 1, aggregation 208 of events 206 is performed to generate event groups 210. Aggregation 208 can involve grouping events from a same device into event groups, where neighboring events in an event group have a timestamp gap of less than a defined timestamp gap threshold T. In Stage 2, correlation 212 of events based on event groups 210 is performed. Correlation 212 can involve performing correlation of events within event groups 210 between/across devices. One or more alerts 214 can be generated based on the correlation.

The two-stage process is advantageous for several reasons. Some other systems try to analyze the events based on evenly-divided time windows, where the time windows is predetermined to be a fixed duration. Such method may cause the loss of event connections since the events may be forced to put into separated time windows. The aggregation and correlation method described herein organizes the events based on its occurrence nature to ensure all events with connections to fall into the same event groups. Furthermore, the aggregation and correlation method correlates the events between devices by taking advantage the classified timespan of event groups of each devices. Dynamically set time windows based on event groups can alleviate the issue of unnaturally breaking events into fixed time windows. This two-stage method provides a systematic way to effectively break large-scale network events into small-scale and meaningful events time windows, and help quickly troubleshoot the issues.

The aggregation and correlation method was tested on the millions of event logs collected from a nationwide service provider network spanning 90 days, which consists of hundred hosts/routers. Results show that more than 99% alarms reduction ratio through aggregation on 95% of routers/hosts. The alarm reduction ratio is measured by the number of event groups divided by the total number of alarms. When correlation is applied after aggregation between a few (about ten) hosts/routers, the method was able to reduce the events to only two scenarios of network problems among them.

In the methodology shown in FIG. 2, the process can begin with events and noise 202. Optionally, noise 202 is removed by filter 204. Filter 204 can implement a filtering process to remove noisy events. Filter 204 can improve the results of aggregation 208 and correlation 212.

Stage 1: Aggregation

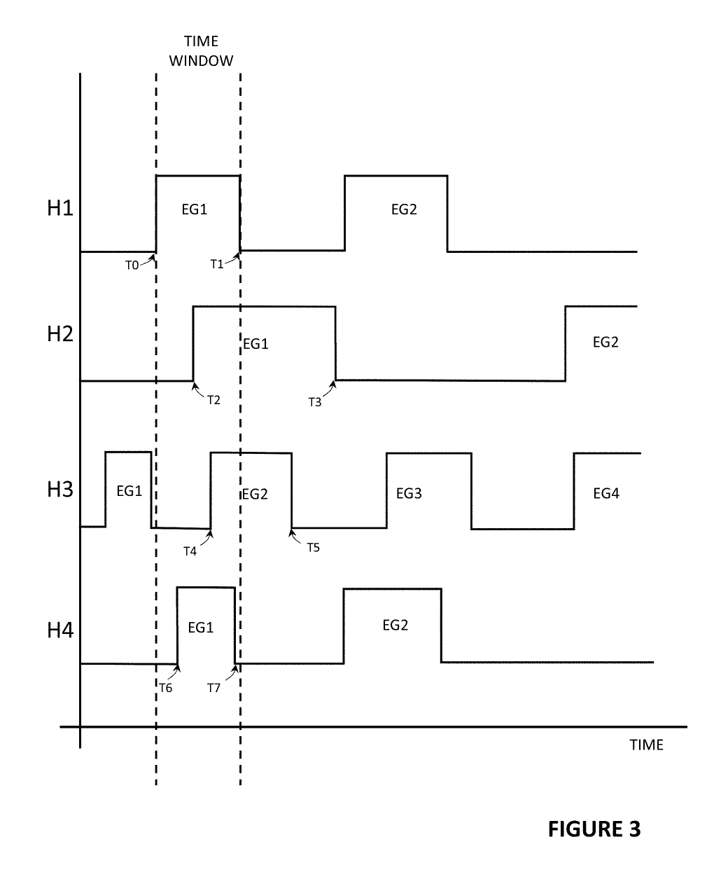

Stage 1, i.e., aggregate 208 of FIG. 2, involves aggregating alarms/events (e.g., events 206 of FIG. 2) based on their timely inherent relationship on the same device. An aggregation rule can be used to generate event groups. FIG. 3 illustrates exemplary event groups, according to some embodiments of the disclosure. The rule can organize the alarms/events from the same device into event groups within which any neighboring alarms/events have the timestamp gap less than T secs. The gap of T sec can be defined based on network protocol convergence time, which should be within 1 minutes in most network protocol designs. In some embodiments, the defined timestamp gap threshold is determined based on a convergence time of a network having the devices. The aggregation rule breaks all events from the same device into multiple event groups between which the last event of group X has at least time gap T sec to the first event of neighbor group X+1.

According to one aspect, an aggregation rule (e.g., in aggregate 208 of FIG. 2) is applied to the events in the log. The rule creates event groups for each host based on a time-based gap T. All alarms are merged into a single group so long as the time between the neighboring events are less than T. If there is a “quiet period” between two alarms greater than T, then the event group ends, and the subsequent event may be a candidate for the next event group.

In some embodiments, aggregation involves one or more of the following. (1) Compare timestamp of all successive or neighboring alarms. (2) Event group numbers are created for each host based on time-based gap. (3) All events have same event group number (single group) until there is a gap greater than T (e.g., if the timestamp difference is more than T from preceding events, the subsequent events can be grouped into next event group). (4) Add group tag with event group number to the grouped events.

The result of aggregation means that each host has a set of (one or more) event groups. For Host 1 “H1”, the events have been aggregated into event group 1 “EG1” and event group 2 “EG2”. For Host 2 “H2”, the events have been aggregated into event group 1 “EG1” and event group 2 “EG2”. For Host 3 “H3”, the events have been aggregated into event group 1 “EG1”, event group 2 “EG2”, event group 3 “EG3”, and event group 4 “EG4”. For Host 4 “H4”, the events have been aggregated into event group 1 “EG1” and event group 2 “EG2”. T can vary depending on the system. Note that the time spans within each event group could be larger or smaller than T, and the time spans may be different from groups to groups.

The events within each group may have the inherent relationship of events triggering issues and their chain reactions. Some identical events may happen at high frequency which could break the efficiency of the aggregation rule. The identical events may be considered as noise. Referring back to FIG. 2, filter 204 can suppress the identical events to remove the noise can be removed. The identical events can be suppressed by following a repeated events suppression rule. The rule can organize all identical events (rather than timestamp) occurring at high frequency into a single event. According to another aspect, a repeated events suppression rule (e.g., in filter 204) is applied to the alarms in the log. The rule helps to clear noise in the log. Identical alarms occurring at high frequency are considered noise. In other words, those identical alarms are merged into a single merged event to clear the noise.

In some embodiments, repeated events suppression involves one or more of the following. (1) Identifying noise, where noise is a group of identical alarms occurring at high frequency, which may have one or more of the following properties: same hostname, same message type, same message description, and same severity. (2) Merging noise to create a single merged event, resulting in clearing the noise. No data is lost (suppressed events are not removed or deleted from the system, but are preserved in storage.) A merged event comprises a group of events based on, e.g., the same host, message type and description. Merged event filters the noise by merging all repeated events into single merged event. Merged event reduces the events that are related to single host. An operator can view each event/alarm within the merged event along with the timestamps (first event time, last event time & all the details inserted with the events), if desired.

Stage 2: Correlation

Once the events are merged, correlation can occur. In some cases, event groups provides a new time base for which correlation can happen. After aggregation, the method performs correlation. In particular, Stage 2, i.e., correlate 212 of FIG. 2, involves correlating the alarms/events between devices based on the event groups formed in Stage 1 (as illustrated by FIG. 3). Correlation can be performed based on one or more of the following: time window, time window and match, topology, and similarity based algorithm. Time windows are time-based group created based on the maximum time zone in which possible correlated events are to occur. For instance, the time window can be defined by a time span of a selected event group. There can be time window overlap between the event groups of different devices. Correlation can also occur based on dynamically determined time frames (a more fine grained time window) having the most event density. The following passages accompanying FIGS. 3-5 illustrate how time windows and time frames can be determined.

According to one aspect, correlation 212 of FIG. 2 examines time windows, and determines whether event groups from multiple hosts have overlap or other heuristics which suggests correlation. Time window used in this stage can be dynamically set, e.g., based on the duration of time spanned by a particular event group. Referring back to FIG. 3, it can be seen that the span of EG1 for H1 sets a time window. It can be seen from the FIGURE that EG1 of H1 has overlap with EG1 of H2, EG2 of H3, and EG1 of H4. This correlation enables alerts to be generated, so that a human operator can zoom into this particular time window to troubleshoot issues. In some cases, the time window having the same span is repeated for the rest of the data, and correlation is performed for the repeated time windows.

Overlapping event groups (and other heuristics) can strongly indicate the event relationship between hosts. In some embodiments, performing correlation of events comprises determining correlation if event groups from different devices overlap with each other within a time window. In some embodiments, event groups from different devices/hosts having some overlap with each other within a particular time window suggests that the event groups are correlated. In some embodiments, other heuristics are used to determine correlation within a time window. When correlation is found, an alert can be generated to assist an operator with troubleshooting. For instance, that time window and potentially those hosts having those overlapping event groups can be flagged. The flagging of time window and/or event groups can greatly reduce the amount of time an operator needs to analyze a large log.

Similar to determining correlation within a time window, it is also possible to determine correlation within time frames. A time frame is also a dynamically set time period like time windows, but time frames have finer granularity. According to one aspect, a correlation method includes one or more of the following. (1) Create time windows, e.g., based on a time span of a selected event group. (2) Divide the time window into multiple time frames of finer granularity, which is the time zone in which two or more related events can occur. Time frames can be defined by starting and/or ending timestamps of event groups within a time window. In some cases, the size of time frame can be manually defined, which can divide a time window into fixed number of time frames based on a fixed time period set for a size of a time frame. In other cases, the size of time frame can be dynamically defined based on the data. The time frame size can be selected based on the probability of occurrence of related events. In some embodiments, the correlation method determines a time frame among time frames which yields more correlated events. The time frames can determined based on starting and ending time stamps of event groups which overlap in time. Performing correlation of events would be done based on the determined time frame. Starting point of the time frame can be based on the occurrence of the first event or a selected event group.

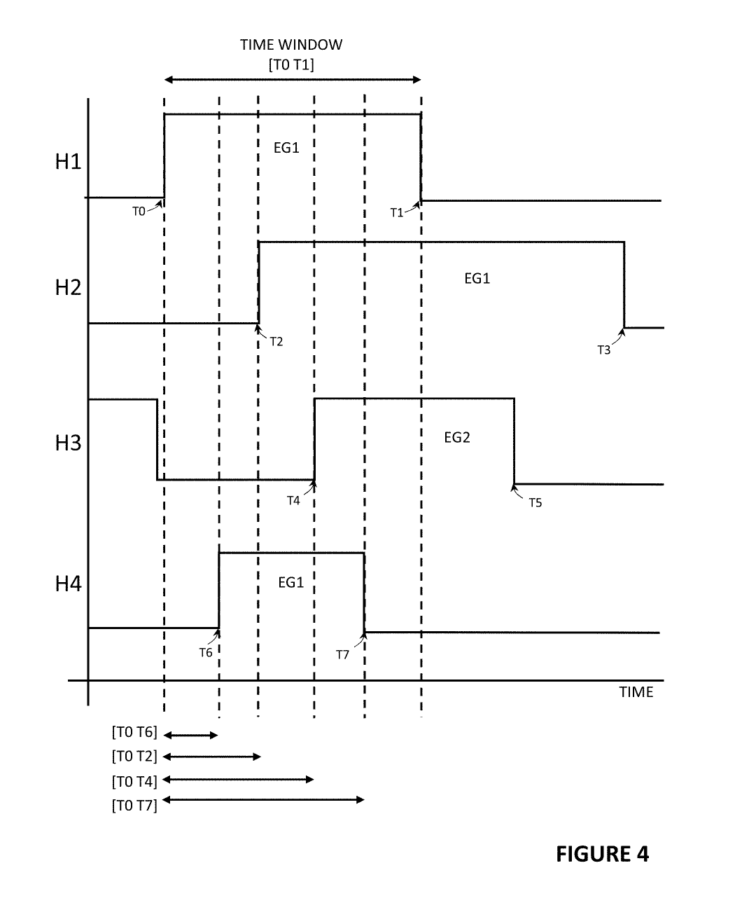

FIG. 4 illustrates a method for determining time frames, according to some embodiments of the disclosure. As discussed previously, time frames enable the correlation to zoom into smaller time periods for more specific or precise correlation and troubleshooting. Within a time frame, event density may be higher than the event density of a wider time window. In this example shown, four hosts (Host1, Host2, Host3, and Host4) has overlapping event groups, shown as H1-EG1, H2-EG1, H3-EG2, and H4-EG1. A time window has been defined based on an event group H1-EG1, having a starting time of T0 and ending time of T1, denoted as [T0 T1]. The FIGURE also shows possible time frames, i.e., smaller time periods, which can be defined within the time window [T0 T1]. The possible time frames are defined based on starting times and/or ending times of other event groups. The starting time of the possible time frames all begin with the starting time of the time window based on event group H1-EG1, i.e., T0. In this example shown, the possible time frames are: [T0 T6], [T0 T2], [T0 T4], and [T0 T7]. To determine a suitable time frame, an iterative method examines the possible time frames, and assesses whether any of them has more overlapping event groups than the other possible time frames. This method enables a search for a finer time period which yields more correlated events. Within possible time frame [T0 T6], one event group is present. Within possible time frame [T0 T2], two overlapping event groups are present. Within possible time frame [T0 T4], three overlapping event groups are present. Within possible time frame [T0 T7], four overlapping event groups are present. One suitable candidate time window having more correlated events (or overlapping event groups) is the time frame [T0 T7]. During [T0 T7], four event groups are overlapping each other, while other time frames have less overlapping event groups. The method can converge to time window [T0 T1], if all possible time frames yield less than the number of overlapping event groups during the time window [T0 T1]. Once a suitable time frame is determined (e.g., [T0 T7]), correlation of events can be done between events occurring during the time frame across hosts.

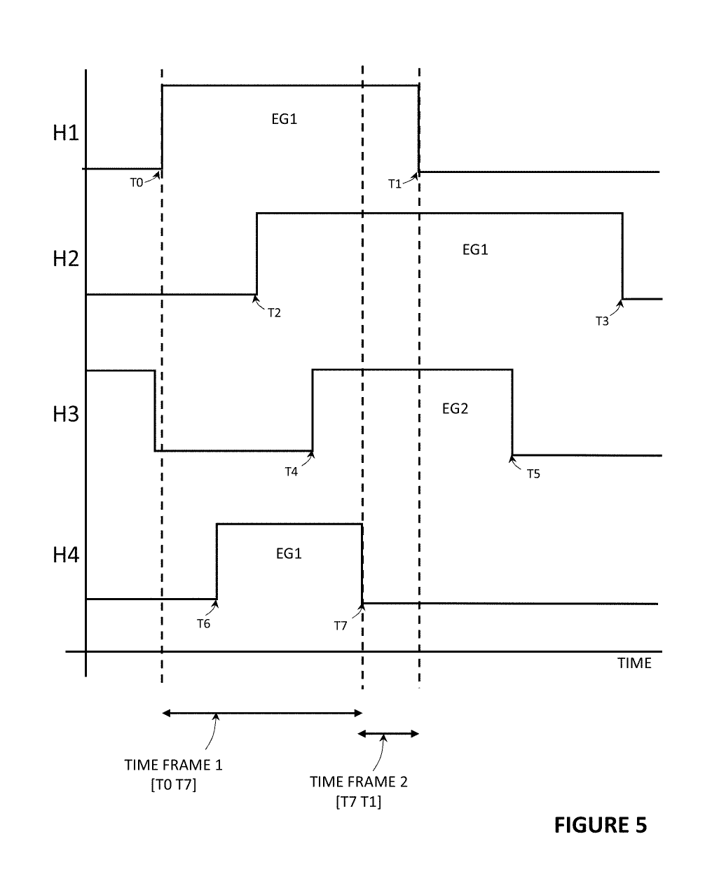

FIG. 5 illustrates exemplary time frames within a time window, according to some embodiments of the disclosure. Once a suitable time frame is determined based on the iterative method described in relation to FIG. 4, the same iterative method can be applied to determine a next suitable time frame for correlation of events. Suppose time frame 1[T0 T7] has been determined, the ending time of time frame 1 T7 can serve as the starting time of the next set of possible time frames. As an illustration, time frame 2 [T7 T1] is found to be the next suitable time frame. The iterative method can be repeated to determine time frames across time. As a result, time frames of various durations can be created. Correlation of events can occur on the basis of such time frames.

Besides examining overlapping event groups or events during a time window or time frame, other heuristics can be applied to assess correlation.

For instance, a time window/frame and match correlation method can extend beyond examining overlap between event groups or events. The time window/frame and match correlation method can correlate alarms that belong to the same time window having identical parameters/attributes (e.g., same message type, message description, severity, and location, etc.). In some cases, matching parameters/attributes replaces examining overlap between time spans of event groups within a time window/frame. Performing correlation of events would include performing correlation of events based on matching of attributes of the events.

In another instance, a similarity algorithm determines correlation even when not all parameters/attributes match. In some cases, the similarity algorithm can provide an additional feature to optimize the match based on any fields. Similarity based algorithm gives option to match any single field or combination of multiple fields (and/or) approximately or accurately match. For example: two message description that are 80% match can be found to be correlated. Two events having three (3) out of four (4) parameters/attributes matching can be correlated. Rules can be provided to define similarity and correlation.

In yet another instance, a topology method can be used to assess correlation. In some cases, the topology method may add value to the time window method and time window and match correlation method. After the alarms are grouped based on time frame and matching message type, it is possible to eliminate the hosts which are not connected or related to each other based on topology. The topology may be predetermined. Performing correlation of events can include performing correlation of events based on topology of hosts which generated the events.

Exemplary Method

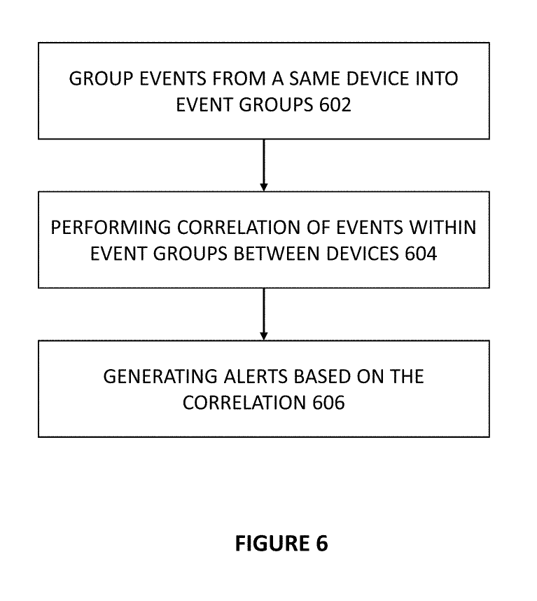

FIG. 6 shows a flow diagram illustrating an exemplary method for heuristic alarm and event aggregation and correlation, according to some embodiments of the disclosure. In 602, events from a same device are grouped into event groups. Neighboring events in an event group have a timestamp gap of less than a defined timestamp gap threshold. In 604, correlation of events is performed within event groups between devices. In 606, one or more alerts are generated based on the correlation.

Exemplary Data Processing System Having Alarm Processing Functionalities

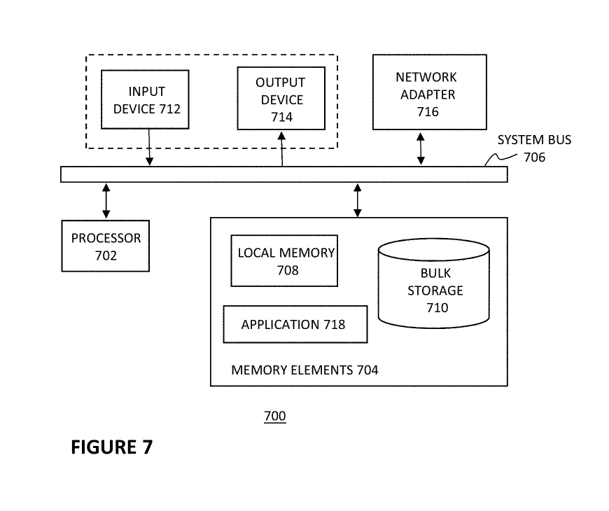

FIG. 7 depicts a block diagram illustrating an exemplary data processing system 700 that may be used to implement alarm processing, according to some embodiments of the disclosure. For instance, a system for heuristic event aggregation and correlation having an alarm processor implemented thereon may have one or more of the components of the data processing system 700 or their functionalities may be implemented with one or more components of data processing system 700. As shown in FIG. 7, the data processing system 700 may include at least one processor 702 coupled to memory elements 704 through a system bus 706. As such, the data processing system may store program code within memory elements 704. Further, the at least one processor 702 may execute the program code accessed from the memory elements 704 via a system bus 706. In one aspect, the data processing system may be implemented as a computer that is suitable for storing and/or executing program code. It should be appreciated, however, that the data processing system 700 may be implemented in the form of any system including a processor and a memory that is capable of performing the functions described within this specification.

The memory elements 704 may include one or more physical memory devices such as, for example, local memory 708 and one or more bulk storage devices 710. The local memory may refer to random access memory or other non-persistent memory device(s) generally used during actual execution of the program code. A bulk storage device may be implemented as a hard drive or other persistent data storage device. The data processing system 700 may also include one or more cache memories (not shown) that provide temporary storage of at least some program code in order to reduce the number of times program code must be retrieved from the bulk storage device 710 during execution.

Input/output (I/O) devices depicted as an input device 712 and an output device 714 optionally can be coupled to the data processing system. Examples of input devices may include, but are not limited to, a keyboard, a pointing device such as a mouse, or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 7 with a dashed line surrounding the input device 712 and the output device 714). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 716 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 700, and a data transmitter for transmitting data from the data processing system 700 to said systems, devices and/or networks. Modems, cable modems, and Ethernet cards are examples of different types of network adapter that may be used with the data processing system 700.

As pictured in FIG. 7, the memory elements 704 may store an application 718. In various embodiments, the application 718 may be stored in the local memory 708, the one or more bulk storage devices 710, or apart from the local memory and the bulk storage devices. It should be appreciated that the data processing system 700 may further execute an operating system (not shown in FIG. 7) that can facilitate execution of the application 718. The application 718, being implemented in the form of executable program code, can be executed by the data processing system 700, e.g., by the at least one processor 702. Responsive to executing the application, the data processing system 700 may be configured to perform one or more operations or method steps described herein.

Persons skilled in the art will recognize that while the elements 702-718 are shown in FIG. 7 as separate elements, in other embodiments their functionality could be implemented in lesser number of individual elements or distributed over a larger number of components.

### Examples

Example 1 is a method for heuristic event aggregation and correlation, the method comprising: grouping events from a same device into event groups, where neighboring events in an event group have a timestamp gap of less than a defined timestamp gap threshold; performing correlation of events within event groups between devices; and generating one or more alerts based on the correlation.

In Example 2, Example 1 can optionally include the defined timestamp gap threshold being determined based on a convergence time of a network having the devices.

In Example 3, Example 1 or 2 can optionally include performing correlation of events comprising: determining correlation if event groups from different devices overlap with each other within a time window.

In Example 4, any one of the above Examples can optionally include the time window being defined by a time span of a selected event group.

In Example 5, any one of the above Examples can optionally include determining a time frame among time frames which yields more correlated events; wherein the determined time frame is determined based on starting and ending timestamps of event groups which overlap in time, and performing correlation of events comprises performing correlation based on the determined time frame.

In Example 6, any one of the above Examples can optionally include performing correlation of events comprising: performing correlation of events based on matching of attributes of the events.

In Example 7, any one of the above Examples can optionally include performing correlation of events comprising: performing correlation of events based on topology of hosts which generated the events.

Example 8 is a system for heuristic event aggregation and correlation, the system comprising: at least one memory element; at least one processor coupled to the at least one memory element; an alarm processor that when executed by the at least one processor is operable to: group events from a same device into event groups, where neighboring events in an event group have a timestamp gap of less than a defined timestamp gap threshold; perform correlation of events within event groups between devices; and generate one or more alerts based on the correlation.

In Example 9, Example 8 can optionally include the defined timestamp gap threshold being determined based on a convergence time of a network having the devices.

In Example 10, Example 8 or 9 can optionally include performing correlation of events comprising: determining correlation if event groups from different devices overlap with each other within a time window.

In Example 11, any one of Examples 8-10 can optionally include the time window being defined by a time span of a selected event group.

In Example 12, any one of Examples 8-11 can optionally include the alarm processor being further operable to: determine a time frame among time frames which yields more correlated events; wherein the determined time frame is based on starting and ending timestamps of event groups which overlap in time, and performing correlation of events comprises performing correlation based on the determined time frame.

In Example 13, any one of Examples 8-12 can optionally include performing correlation of events comprising: performing correlation of events based on matching of attributes of the events.

In Example 14, any one of Examples 8-13 can optionally include performing correlation of events comprising: performing correlation of events based on topology of hosts which generated the events.

Example 15 has one or more computer-readable non-transitory media comprising one or more instructions, for heuristic event aggregation and correlation, that when executed on a processor configure the processor to perform one or more operations comprising: grouping events from a same device into event groups, where neighboring events in an event group have a timestamp gap of less than a defined timestamp gap threshold; performing correlation of events within event groups between devices; and generating one or more alerts based on the correlation.

In Example 16, Example 15 can optionally include the defined timestamp gap threshold being determined based on a convergence time of a network having the devices.

In Example 17, Example 15 or 16 can optionally include performing correlation of events comprising: determining correlation if event groups from different devices overlap with each other within a time window.

In Example 18, any one of Examples 15-17 can optionally include the time window being defined by a time span of a selected event group.

In Example 19, any one of Examples 15-18 can optionally include the one or more operations further having: determining a time frame among time frames which yields more correlated events; wherein the determined time frame is determined based on starting and ending timestamps of event groups which overlap in time, and performing correlation of events comprises performing correlation based on the determined time frame.

In Example 20, any one of Examples 15-19 can optionally include performing correlation of events comprising one or more of the following: performing correlation of events based on matching of attributes of the events, and performing correlation of events based on topology of hosts which generated the events.

Example 22 is an apparatus comprising means for carrying out or implementing any one of the methods in Examples 1-7.

Variations and Implementations

Within the context of the disclosure, a network used herein represents a series of points, nodes, or network elements of interconnected communication paths for receiving and transmitting packets of information that propagate through a communication system. A network offers communicative interface between sources and/or hosts, and may be any local area network (LAN), wireless local area network (WLAN), metropolitan area network (MAN), Intranet, Extranet, Internet, wide area network (WAN), virtual private network (VPN), or any other appropriate architecture or system that facilitates communications in a network environment depending on the network topology. A network can comprise any number of hardware or software elements coupled to (and in communication with) each other through a communications medium.

In one particular instance, the architecture of the present disclosure can be associated with a service provider deployment. In other examples, the architecture of the present disclosure would be equally applicable to other communication environments, such as an enterprise WAN deployment, The architecture of the present disclosure may include a configuration capable of transmission control protocol/internet protocol (TCP/IP) communications for the transmission and/or reception of packets in a network.

As used herein in this specification, the term ‘network element’ is meant to encompass any of the aforementioned elements, as well as servers (physical or virtually implemented on physical hardware), machines (physical or virtually implemented on physical hardware), end user devices, routers, switches, cable boxes, gateways, bridges, loadbalancers, firewalls, inline service nodes, proxies, processors, modules, or any other suitable device, component, element, proprietary appliance, or object operable to exchange, receive, and transmit information in a network environment. These network elements may include any suitable hardware, software, components, modules, interfaces, or objects that facilitate the heuristic alarm and event aggregation and correlation operations thereof. This may be inclusive of appropriate algorithms and communication protocols that allow for the effective exchange of data or information.

In one implementation, components for heuristic alarm and event aggregation and correlation may include software to achieve (or to foster) the functions discussed herein for heuristic alarm and event aggregation and correlation where the software is executed on one or more processors to carry out the functions. This could include the implementation of instances of modules and/or any other suitable element that would foster the activities discussed herein. Additionally, each of these elements can have an internal structure (e.g., a processor, a memory element, etc.) to facilitate some of the operations described herein. In other embodiments, these functions for heuristic alarm aggregation and correlation may be executed externally to these elements, or included in some other network element to achieve the intended functionality. Alternatively, components may include software (or reciprocating software) that can coordinate with other network elements in order to achieve the heuristic alarm and event aggregation and correlation functions described herein. In still other embodiments, one or several devices may include any suitable algorithms, hardware, software, components, modules, interfaces, or objects that facilitate the operations thereof.

In certain example implementations, the heuristic alarm and event aggregation and correlation functions outlined herein may be implemented by logic encoded in one or more non-transitory, tangible media (e.g., embedded logic provided in an application specific integrated circuit [ASIC], digital signal processor [DSP] instructions, software [potentially inclusive of object code and source code] to be executed by one or more processors, or other similar machine, etc.). In some of these instances, one or more memory elements can store data used for the operations described herein. This includes the memory element being able to store instructions (e.g., software, code, etc.) that are executed to carry out the activities described in this specification. The memory element is further configured to store databases to enable heuristic alarm and event aggregation and correlation disclosed herein. The processor can execute any type of instructions associated with the data to achieve the operations detailed herein in this specification. In one example, the processor could transform an element or an article (e.g., data) from one state or thing to another state or thing. In another example, the activities outlined herein may be implemented with fixed logic or programmable logic (e.g., software/computer instructions executed by the processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

Any of these elements (e.g., the network elements, etc.) can include memory elements for storing information to be used in achieving heuristic alarm and event aggregation and correlation, as outlined herein. Additionally, each of these devices may include a processor that can execute software or an algorithm to perform the heuristic alarm and event aggregation and correlation activities as discussed in this specification. These devices may further keep information in any suitable memory element [random access memory (RAM), ROM, EPROM, EEPROM, ASIC, etc.], software, hardware, or in any other suitable component, device, element, or object where appropriate and based on particular needs. Any of the memory items discussed herein should be construed as being encompassed within the broad term ‘memory element.’ Similarly, any of the potential processing elements, modules, and machines described in this specification should be construed as being encompassed within the broad term ‘processor.’ Each of the network elements can also include suitable interfaces for receiving, transmitting, and/or otherwise communicating data or information in a network environment.

Additionally, it should be noted that with the examples provided above, interaction may be described in terms of two, three, or four network elements. However, this has been done for purposes of clarity and example only. In certain cases, it may be easier to describe one or more of the functionalities of a given set of flows by only referencing a limited number of network elements. It should be appreciated that the systems described herein are readily scalable and, further, can accommodate a large number of components, as well as more complicated/sophisticated arrangements and configurations. Accordingly, the examples provided should not limit the scope or inhibit the broad techniques of heuristic alarm and event aggregation and correlation, as potentially applied to a myriad of other architectures.

It is also important to note that the steps described herein illustrate only some of the possible scenarios that may be executed by, or within, the components for implementing heuristic alarm and event aggregation and correlation described herein. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by components for implementing heuristic alarm and event aggregation and correlation in that any suitable arrangements, chronologies, configurations, and timing mechanisms may be provided without departing from the teachings of the present disclosure.

It should also be noted that many of the previous discussions may imply a single client-server relationship. In reality, there is a multitude of servers in the delivery tier in certain implementations of the present disclosure. Moreover, the present disclosure can readily be extended to apply to intervening servers further upstream in the architecture, though this is not necessarily correlated to the ‘m’ clients that are passing through the ‘n’ servers. Any such permutations, scaling, and configurations are clearly within the broad scope of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

One or more advantages mentioned herein does not in any way suggest that any one of the embodiments necessarily provides all the described advantages or that all the embodiments of the disclosure necessarily provide any one of the described advantages.

What is claimed is:

1. A method for heuristic event aggregation and correlation, the method comprising:
grouping events from a same device into event groups, where neighboring events in an event group have a timestamp gap of less than a defined timestamp gap threshold;
performing correlation of events within event groups between devices; and
generating one or more alerts based on the correlation.

2. The method of claim 1, wherein the defined timestamp gap threshold is determined based on a convergence time of a network having the devices.

3. The method of claim 1, wherein performing correlation of events comprises:
determining correlation if event groups from different devices overlap with each other within a time window.

4. The method of claim 3, wherein the time window is defined by a time span of a selected event group.

5. The method of claim 1, further comprising:
determining a time frame among time frames which yields more correlated events;
wherein the determined time frame is determined based on starting and ending timestamps of event groups which overlap in time, and performing correlation of events comprises performing correlation based on the determined time frame.

6. The method of claim 1, wherein performing correlation of events comprises:
performing correlation of events based on matching of attributes of the events.

7. The method of claim 1, wherein performing correlation of events comprises:
performing correlation of events based on topology of hosts which generated the events.

8. A system for heuristic event aggregation and correlation, the system comprising:
at least one memory element;
at least one processor coupled to the at least one memory element;
an alarm processor that when executed by the at least one processor is operable to:
group events from a same device into event groups, where neighboring events in an event group have a timestamp gap of less than a defined timestamp gap threshold;
perform correlation of events within event groups between devices; and
generate one or more alerts based on the correlation.

9. The system of claim 8, wherein the defined timestamp gap threshold is determined based on a convergence time of a network having the devices.

10. The system of claim 8, wherein performing correlation of events comprises:
determining correlation if event groups from different devices overlap with each other within a time window.

11. The system of claim 10, wherein the time window is defined by a time span of a selected event group.

12. The system of claim 8, wherein the alarm processor is further operable to:
determine a time frame among time frames which yields more correlated events;
wherein the determined time frame is based on starting and ending timestamps of event groups which overlap in time, and performing correlation of events comprises performing correlation based on the determined time frame.

13. The system of claim 8, wherein performing correlation of events comprises:
performing correlation of events based on matching of attributes of the events.

14. The system of claim 8, wherein performing correlation of events comprises:
performing correlation of events based on topology of hosts which generated the events.

15. One or more computer-readable non-transitory media comprising one or more instructions, for heuristic event aggregation and correlation, that when executed on a processor configure the processor to perform one or more operations comprising:
grouping events from a same device into event groups, where neighboring events in an event group have a timestamp gap of less than a defined timestamp gap threshold;
performing correlation of events within event groups between devices; and
generating one or more alerts based on the correlation.

16. The one or more computer-readable non-transitory media of claim 15, wherein the defined timestamp gap threshold is determined based on a convergence time of a network having the devices.

17. The one or more computer-readable non-transitory media of claim 15, wherein performing correlation of events comprises:
determining correlation if event groups from different devices overlap with each other within a time window.

18. The one or more computer-readable non-transitory media of claim 17, wherein the time window is defined by a time span of a selected event group.

19. The one or more computer-readable non-transitory media of claim 15, wherein the one or more operations further comprises:
determining a time frame among time frames which yields more correlated events;
wherein the determined time frame is determined based on starting and ending timestamps of event groups which overlap in time, and performing correlation of events comprises performing correlation based on the determined time frame.

20. The one or more computer-readable non-transitory media of claim 15, wherein performing correlation of events comprises one or more of the following:
performing correlation of events based on matching of attributes of the events, and
performing correlation of events based on topology of hosts which generated the events.
